(19) United States
(12) Patent Application Publication
(10) Pub. No.: US 2024/0246390 A1
(43) Pub. Date: Jul. 25, 2024

(54) HVAC RECIRCULATION SYTEM WITH IMPROVED ENERGY EFFICIENCY

(71) Applicant: SKYTREE B.V., Amsterdam (NL)

(72) Inventors: René BECKER, Amsterdam (NL); Maxiums Llewelyn BEAUMONT, Amsterdam (NL); Mathew BERES, Amsterdam (NL)

(73) Assignee: SKYTREE B.V., Amsterdam (NL)

(21) Appl. No.: 18/684,310

(22) PCT Filed: Aug. 17, 2022
(86) PCT No.: PCT/NL2022/050472

§ 371 Date: Feb. 16, 2024

(30) Foreign Application Priority Data
Aug. 17, 2021 (NL) 2028983

(51) Int. Cl. B60H 1/00

(52) U.S. Cl. CPC B60H 1/0073; B60H 1/00785; B60H 1/008; B60H 1/00849

(57) ABSTRACT

Method for optimizing energy use in vehicles comprising an air-circulation and -recirculation system, the method comprising the steps of measuring a carbon dioxide level of vehicle cabin air, a relative humidity level of cabin air and at least one temperature of at least one window, providing the measured carbon dioxide level, the relative humidity level and the temperature to a processing unit, providing a desired cabin temperature and an indexed optimal carbon dioxide level to the processing unit, calculating deviation of the measured cabin air carbon dioxide level from the indexed optimal carbon dioxide level, calculating optimal cabin air relative humidity level based on the desired cabin temperature, and, based on the calculation, determining the optimal rate at which to provide outside air to the cabin to achieve the calculated optimal cabin air relative humidity level and the indexed optimal carbon dioxide level, determining the recirculation rate required to provide outside air to the cabin at the determined optimal rate and providing instructions to an air-circulation and -recirculation control unit to provide air to the cabin of the vehicle at the optimal rate.

The present invention relates to a method for optimizing energy use in vehicles comprising an air-circulation and -recirculation system, a vehicle energy optimization apparatus for use in the method, a vehicle comprising the energy optimization apparatus and a kit of parts for use in modifying a vehicle equipped with an air-circulation and -recirculation system. The invention further relates to a computer programme comprising instructions which, when the programme is executed by a computer, causes the computer to carry out the method for optimizing energy use in vehicles, a computer-readable medium comprising instructions which, when executed by a computer, cause the computer to carry out the steps of the method and a method of improving the energy efficiency of a vehicle.

### BACKGROUND OF THE INVENTION

Vehicle air conditioning systems have been used since the 1930's and have been developed into Heating, Ventilation and Air Conditioning (HVAC) systems that are currently standard on almost all mass-produced vehicles. These vehicle HVAC systems enable the user of a vehicle to control the temperature of the interior cabin of an automobile by either heating the interior of the cabin above ambient temperature or cooling the interior below ambient temperature. This ability to control the temperature of the interior of a vehicle advantageously allows for user comfort.

Vehicle air conditioning systems that only use outside (fresh) air as the source of air to a vehicle are typically energy inefficient as the air typically has to be heated or cooled from ambient temperature to a temperature selected by the user. One solution to this inefficiency is to recirculate air within a vehicle cabin through a heating and/or cooling element, thereby enabling control of the temperature of the interior of a vehicle without relying on the continuous provision of external air. This is typically more energy efficient as the temperature of the air already within the cabin is typically closer to the desired temperature than ambient, outside (fresh) air.

However, if air is continuously recirculated and no outside (fresh) air provided, then the amount of carbon dioxide and humidity within the cabin will rise during vehicle use. This is due to the user's respiration within the vehicle consuming oxygen and exhaling carbon dioxide and water. The American Society of Heating, Refrigeration and Air Conditioning Engineers places the comfort limit for carbon dioxide levels at approximately 700 parts per million (ppm) above the ambient level (approximately 400 ppm). Most people find a carbon dioxide level above 1,100 ppm to be uncomfortable. At higher concentrations, such as above 5,000 ppm, carbon dioxide can cause drowsiness. This is a safety issue for the vehicle user, vehicle passengers and/or society in generally, as increased driver drowsiness is correlated with increased risk of accidents. It is estimated that fatigue is involved in between 10 and 25% of all vehicle accidents, and high vehicle cabin carbon dioxide levels are a known contributory factor to driver fatigue.

To minimize carbon dioxide concentration, nearly all mass manufactured vehicles are configured to introduce an excessive amount of outside (fresh) air to the cabin of the vehicle during use, typically in excess of 220 m³ per hour. This volume of outside (fresh) air must be brought close to the user selected cabin temperature from ambient temperature, thus the measure to preclude the risk of excessive carbon dioxide concentration within the vehicle cabin comes at a significant energy cost.

US 2002/0197949 A1 describes the state of the art for maximizing recirculation of air to minimise energy expenditure on HVAC systems relying on an estimate of the CO₂ emissions by vehicle occupants. Crucially, these systems do not employ any carbon dioxide sensors. One disadvantage of systems of this type is that they either need to determine the number of vehicle occupants or rely on the maximum occupancy rating of the vehicle (typically 5 occupants) and therefore utilise an excessive amount of outside (fresh) air. The assumption is that every occupant generates the same amount of carbon dioxide, which leads to inefficiencies in the HVAC system.

In a modern vehicle, the air conditioning system will use around 5 to 6 kW of the engine's power, thus increasing fuel consumption of the vehicle. This lowers the overall miles per gallon efficiency for a petrol, diesel or hybrid vehicle or the miles per gallon gasoline equivalent for electric vehicles. It is an outstanding challenge in the area of vehicle air conditioning to improve the energy efficiency of air conditioning systems without compromising user safety or comfort.

### BRIEF SUMMARY OF THE DISCLOSURE

According to the present disclosure there is provided a method for optimizing energy use in vehicles comprising an air-circulation and -recirculation system, the method comprising the steps of:
i. measuring a carbon dioxide level of vehicle cabin air; a relative humidity level of cabin air and at least one temperature of at least one vehicle window; and
ii. providing the measured carbon dioxide level, relative humidity level and temperature to a processing unit;
iii. providing a desired cabin temperature and an indexed optimal carbon dioxide level to the processing unit;
iv. calculating deviation of the measured cabin air carbon dioxide level from the indexed optimal carbon dioxide level(s); calculating optimal cabin air relative humidity level based on desired cabin temperature; and, based on the calculation,
v. determining the optimal rate at which to provide outside air to the cabin to achieve calculated cabin air optimal relative humidity level and carbon dioxide level, and minimize energy use;
vi. determining the recirculation rate required to provide outside air to the cabin at the determined optimal rate; and
vii. providing instructions to the air-circulation and -recirculation control unit to provide outside air to the cabin of the vehicle at the optimal rate by varying the recirculation rate.

The disclosure further relates to a vehicle energy optimization apparatus for use in the method.

The disclosure further relates to a vehicle comprising the energy optimization apparatus and a kit of parts for use in modifying a vehicle equipped with an air-circulation and—recirculation system.

The disclosure further relates to a computer programme comprising instructions which, when the programme is executed by a computer, causes the computer to carry out the method for optimizing energy use in vehicles, a computer-readable medium comprising instructions which, when executed by a computer, cause the computer to carry out the steps of the method.

The disclosure further relates to a method of improving the energy efficiency of a vehicle.

The disclosure further relates to a method of providing a vehicle control system with real-time relative humidity level and carbon dioxide level data.

### BRIEF DESCRIPTION OF THE FIGURES

FIG. 1 is a graph of HVAC power reduction in % against recirculation rate. A recirculation rate of 0 corresponds to a situation where 100% of the air is provided from the outside during the simulation (i.e. zero recirculation). A recirculation rate of 100% corresponds to a situation where 100% of the air is recirculated during the simulation (i.e. no air from outside the cabin).

FIG. 2 is a graph of the effect of increased air recirculation on energy savings and vehicle extension. The recirculation rate is plotted against vehicle range extension on the left axis and energy savings on the right axis.

FIG. 3 is a graph of the simulated CO₂ concentration within the cabin (y-axis, ppm) against time (x-axis, s) under different recirculation rates (0.4, 0.6 and 0.8).

FIG. 4 is a graph of the simulated maximum CO₂ concentrations observed within the cabin (y axis, ppm) against various recirculation rates (from zero to 1).

FIG. 5 is a graph of CO₂ concentration (y-axis, ppm) against time (x-axis, s) for the recirculation rate of 0.75. The solid line is the CO₂ concentration that is obtained in the simulation, the hashed line is the maximum (target) CO₂ level.

FIG. 6 is a graph of the relative humidity (left y-axis, %) and cabin temperature (right y-axis, ° C.) against time (x-axis, t), at a recirculation rate of 0.75, with relative humidity depicted by the hashed line and the temperature depicted by the solid line.

FIG. 7 is a graph of relative humidity (left y-axis, %) and temperature (right y-axis, ° C.) against time (x-axis, s), at a recirculation rate of 0.90. The shaded area corresponds to the region where window fogging is expected to occur. The heat-up phase is on the left half of the graph and the steady-state is on the right half of the graph.

FIG. 8 is a graph of maximum cabin relative humidity observed (y-axis, %) against recirculation rate (x-axis, from zero to one) obtained from simulations in (i) the heat up phase and (ii) the steady-state condition.

FIG. 9 is a graph of windshield temperature effect on maximum allowed recirculation rates. The maximum allowed recirculation rate (y-axis, 0.7 to 1.0) is plotted against the windshield temperature (° C.).

### DETAILED DESCRIPTION

A first aspect of the present disclosure concerns a method for optimizing energy use in vehicles comprising an air-circulation and -recirculation system, the method comprising the steps of:
i. measuring a carbon dioxide level of vehicle cabin air; a relative humidity level of cabin air and at least one temperature of at least one vehicle window; and
ii. providing the measured carbon dioxide level, relative humidity level and temperature to a processing unit;
iii. providing a desired cabin temperature and an indexed optimal carbon dioxide level to the processing unit;
iv. calculating deviation of the measured cabin air carbon dioxide level from the indexed optimal carbon dioxide level(s); calculating optimal cabin air relative humidity level based on desired cabin temperature; and, based on the calculation,
v. determining the optimal rate at which to provide outside air to the cabin to achieve calculated cabin air optimal relative humidity level and carbon dioxide level, and minimize energy use;
vi. determining the recirculation rate required to provide outside air to the cabin at the determined optimal rate; and
vii. providing instructions to the air-circulation and -recirculation control unit to provide outside air to the cabin of the vehicle at the optimal rate by varying the recirculation rate.

### Definitions

Recirculation rate is the ratio of the volume of outside air that is circulated to the volume of air that is recirculated.

Relative humidity (Φ) is a measure of the concentration of water vapour present in air. The relative humidity (Φ) of an air-water mixture is defined as the ratio of the partial pressure of water vapour (p_{water}) in the mixture to the equilibrium vapour pressure of water (p*_{water}) over a flat surface of pure water at a given temperature. Φ=(p_{water})/(p*_{water}). Relative humidity is often expressed as a percentage, i.e. Φ(%)=[(p_{water})/(p*_{water})]×100%. At 100% relative humidity the air is saturated with water and is at its dew point.

Desired cabin temperature is the temperature to which the vehicle cabin is set to achieve. This is typically entered by the vehicle user during use of the vehicle. It is typically selected by the vehicle user to ensure comfort whist using the vehicle.

The cabin is the part of the interior of the vehicle that can be occupied by at least one occupant.

The dew point is the temperature to which air must be cooled to become saturated with water vapor (to achieve 100% relative humidity). When air cools to its dew point through contact with a surface that is colder than the air, such as a cold window, water will typically condense on the surface of the window.

The air-circulation and -recirculation control unit is any unit configured to control air-circulation within the cabin of the vehicle and recirculation of cabin air through the air conditioning unit. The air-circulation and -recirculation control unit may be part of a Heating, Ventilation, and Air Conditioning (HVAC) system.

The carbon dioxide level of air inside a cabin space of a vehicle may be measured using a carbon dioxide sensor. Such a carbon dioxide sensor may be selected from commercially available carbon dioxide sensors capable of measuring the carbon dioxide level in the range of 350 to 15,000 ppm. The carbon dioxide sensor should be capable of outputting the measured carbon dioxide level as a computer-readable signal. Preferably, the carbon dioxide level of air inside the cabin space is measured with an accuracy of from 10 to 500 ppm CO₂ over the range of 400 to 5000 ppm CO₂, more preferably an accuracy of from 24 to 350 ppm CO₂, even more preferably of from 40 to 250 ppm CO₂, and most preferably an accuracy of 40 ppm CO₂+5% of the CO₂ reading value.

The relative humidity level of air inside the cabin space of the vehicle may be measured using a relative-humidity sensor. The relative-humidity sensor may be selected from commercially available relative humidity sensors capable of measuring the relative humidity in the range of 0 to 100% relative humidity. Such a relative humidity sensor should be capable of outputting the measured relative humidity level as a computer readable signal.

The temperature of a window may be measured using a temperature sensor. Suitable temperature sensors include thermometers in physical contact with the window. Suitable temperature sensors also include infrared temperature sensors. Preferably, the temperature of the inside surface of the window is measured (the cabin air contacting surface of the window). More preferably, the temperature is measured at the top of the window. The top of the window is defined as the uppermost 25% of the window by volume, where the direction up is opposite to the vector of gravitational acceleration, when the window is fitted to the vehicle. It has been found that the method is particularly effective when the temperature of the inside surface of the window is measured at the top of the window. Without being bound by theory, it is believed that the top of the window is the part of a window most prone to mist or fog up. Most preferably the window is the front windscreen or windshield of the vehicle.

The method comprises the step of providing the measured carbon dioxide level, relative humidity level and window temperature to a processing unit. This may be realised by connecting the output of the sensors to the processing unit via wires.

Alternatively, the step of providing the measured carbon dioxide level, relative humidity level and temperature to a processing unit may be realised using wireless technology in which the sensors output the information as electromagnetic radiation. The processing unit may be configured to receive the broadcast signals. Alternatively, the processing unit may be connected to a receiver configured to receive the broadcast signals, transduce these signals to conducted electrical signals and communicate these to the processing unit using wires. Suitable electromagnetic communication systems may be selected from short-range wireless technology such as Bluetooth, Wi-Fi or infra-red communication.

Bluetooth is a short-range wireless technology standard that is used for exchanging data between fixed and mobile devices over short distances using UHF radio waves in the ISM bands, from 2.402 GHz to 2.48 GHz, and conforms to standard IEEE 802.15 as maintained by the Bluetooth Special Interest Group.

Wi-Fi is a family of wireless network protocols, based on the IEEE 802.11 family of standards, which are commonly used for local-area networking (LAN) of devices, allowing nearby digital devices to exchange data by radio waves. Wi-Fi connection should be according to the IEEE 802.11 standard family as maintained by the Wi-Fi Alliance.

Alternatively, the step of providing the measured carbon dioxide level, relative humidity level and temperature to a processing unit may be realised using a combination of both wires and wireless technology as described above.

The method comprises the step of providing desired cabin temperature to the processing unit. The desired cabin temperature is the temperature to which the vehicle cabin is set to achieve. This temperature is typically entered by the vehicle user during use of the vehicle. As exemplification, a vehicle user might set the cabin temperature dial of a vehicle to 21° C. so as to match their most preferred ambient temperature and thereby ensure comfort. This information may be provided to the processing unit directly by the user using any suitable means, or may be transferred from one or more of the onboard computer(s) of the vehicle using any suitable means. Suitable means include wire connection and wireless connection. Suitable wireless systems are as described above for the steps of providing the sensor data to the processing unit

The method comprises the step of calculating deviation of measured carbon dioxide level of air inside the cabin space of the vehicle from the indexed optimal carbon dioxide level(s). The indexed optimal carbon dioxide level(s) are configured to ensure the comfort of the vehicle user and may, for example, be set to an upper limit of 1,100 ppm.

The method comprises the step of calculating optimal relative humidity level based on desired cabin temperature. The optimal relative humidity level is selected on the basis of (i) known average upper limits for user comfort and (ii) upper limits to avoid fogging of the vehicles window(s), which is a function of the dew point temperature of the air inside the cabin. Typically, the lowest value of the two limits is selected as the target level. The optimal relative humidity level may also be selected to be above the known average lower limits for user comfort.

The method comprises the step of determining the optimal rate at which to provide outside air to the cabin to achieve calculated optimal relative humidity level and carbon dioxide level, and minimize energy use. This may be achieved by means of an algorithm.

The method comprises the step of determining the recirculation rate required to provide outside air to the cabin at the determined optimal rate.

The method comprises the step of providing instructions to an air-recirculation control unit to select a rate at which to provide outside air to the cabin of the vehicle by varying the recirculation rate. The instructions may be provided to the air-recirculation control unit by any suitable means. Suitable means include wire connection and wireless connection. Suitable wireless systems are described above. If the method is employed on a vehicle comprising a HVAC system equipped with a recirculation flap, this step it may instruct the air-recirculation control unit to position the recirculation flap such that the outside (fresh) air intake equals the optimal amount such that the cabin air quality levels are maintained, and HVAC power consumption is minimized. A non-limiting example of this step would be an instruction to the HVAC controller to increase outside (fresh) air intake if the relative humidity level or carbon dioxide level is/are above the optimal relative humidity level and carbon dioxide level.

The claimed method allows for minimization of outside (fresh) air intake whilst maintaining safe and comfortable cabin carbon dioxide levels, cabin relative humidity levels and cabin temperature. This advantageously allows for optimizing (reducing) energy use in vehicles comprising an air-circulation and -recirculation system. This method is particularly advantageous for electric vehicles. In electric vehicles, use of the HVAC system constitutes a major part of the overall energy expenditure of the vehicle. The claimed method advantageously extends the range of the vehicle by reducing battery use by the HVAC system. An additional advantage of the claimed method is that no input is required on the number of occupants in the vehicle, as measurement of the relative humidity level and carbon dioxide level obviates the need to do so.

In a preferred embodiment, the step of measuring at least one temperature of at least one window is measuring at least one temperature of a front windscreen. This means that step (i) would read as “measuring a carbon dioxide level of vehicle cabin air; a relative humidity level of cabin air and at least one temperature of a front windscreen, and”. The method is particularly effective at precluding or reducing the fogging of the front windscreen when the method entails measuring the temperature of the front windscreen. This is particularly advantageous, as fogging of the front windscreen is the most dangerous whilst driving. More preferably, the step of measuring at least one temperature of at least one window is measuring the temperature of the inside surface of the front windscreen, most preferably the step of measuring at least one temperature of at least one window is measuring the temperature of the inside surface of the front windscreen at the top of the windscreen.

In a preferred embodiment, the method step (i) additionally comprises measuring the cabin temperature and step (ii) additionally comprises providing the measured cabin temperature to a processing unit. The temperature inside the cabin space of the vehicle may be measured using a temperature sensor. The temperature sensor may be selected from commercially available temperature sensors. The temperature sensor should be capable of outputting the temperatures as a computer readable signal.

In a preferred embodiment, the method is continuously performed. Where the method is continuously performed, measurements are periodically and/or continuously conducted by the sensors. Where the method is continuously performed, the measured carbon dioxide levels, relative humidity levels and temperatures are periodically and/or continuously provided to a processing unit. Where the method is continuously performed, the desired cabin temperature is to the processing unit at the beginning of the method and is updated if changed during the method. Where the method is continuously performed, deviation of measured carbon dioxide level of air inside the cabin space of the vehicle from the indexed optimal carbon dioxide level(s) is periodically or continuously calculated. Where the method is continuously performed, the optimal relative humidity level based on desired cabin temperature is continuously or periodically determined. Where the method is continuously performed, the optimal rate at which to provide outside (fresh) air to the cabin to achieve calculated optimal relative humidity level and carbon dioxide level is periodically or continuously determined. Where the method is continuously performed, instructions are periodically or continuously provided to an air-recirculation control unit to select a rate at which to provide outside (fresh) air to the cabin of the vehicle.

In a preferred embodiment the method comprises the additional step of measuring the concentration of particulates in the air inside the cabin space of a vehicle using particle detection means. This preferred embodiment also comprises providing the measured concentration of particulates in the air inside the cabin space to a processing unit. This preferred embodiment also comprises determining the optimal rate at which to provide outside (fresh) air to the cabin space to achieve calculated optimal relative humidity level, carbon dioxide level and concentration of particulates in the air inside the cabin space.

This embodiment advantageously allows for minimization of outside (fresh) air intake whilst maintaining safe and comfortable cabin carbon dioxide levels, cabin relative humidity levels, particulate concentration and cabin temperature.

In a preferred embodiment the method comprises the additional step of measuring the level of volatile organic compounds in the air inside the cabin space of a vehicle using volatile organic compound detection means. This preferred embodiment also comprises providing the measured level of volatile organic compounds (VOCs) in the air inside the cabin space to a processing unit. This preferred embodiment also comprises determining the optimal rate at which to provide outside (fresh) air to the cabin space to achieve calculated optimal relative humidity level, carbon dioxide level and level of volatile organic compounds in the air inside the cabin space. Methods of measuring levels of VOCs are known in the art, and any suitable method may be selected, for example by means of mass spectrometry or infrared detection. Preferably, an indexed aggregate VOC level may be measured and provided.

This embodiment advantageously allows for minimization of outside (fresh) air intake whilst maintaining safe and comfortable cabin carbon dioxide levels, cabin relative humidity levels, VOC concentration and cabin temperature. Minimization of VOC concentration is particularly advantageous in reducing foul smells within a vehicle. Examples of VOCs include formaldehyde; polybrominated diphenyl ethers (PBDEs) that are used as flame retardants; and phthalic acid esters (phthalates), which are emitted from materials and finishes used to make vehicle interiors. Exposure can exacerbate allergy and asthma symptoms and cause eye, nose and throat irritation, cough, headache, general flu-like illnesses, and skin irritation. Some also are known to cause cancer and neurological effects. Alternatively, volatile organic compounds may originate from cleaning products and processes used in vehicles.

In a preferred embodiment the method comprises the additional step of measuring the temperature of the front windscreen using a temperature sensor. The temperature may be measured by any suitable means, such as a local temperature probe in contact with the front windscreen or an infrared temperature sensor. This preferred embodiment also comprises providing the measured temperature of the front windscreen to a processing unit. This preferred embodiment also comprises determining the optimal rate at which to provide outside (fresh) air to the cabin space to achieve calculated optimal relative humidity level, carbon dioxide level and preclude fogging of the front windscreen of the vehicle. It has been found that if the temperature of the front windscreen is close to the dew point of air within the cabin, misting of the windscreen can occur. The humidity of the air in the cabin can be decreased in response to advantageously minimize or entirely preclude misting of the windscreen, and hence provide safer driving conditions.

This embodiment advantageously allows for minimization of outside (fresh) air intake whilst maintaining safe and comfortable cabin carbon dioxide levels, cabin relative humidity levels and cabin temperature, whilst also preventing or at least minimizing window fogging. This confers an additional advantage of avoiding the windscreen fogging during use, which can distract the driver's attention.

In a preferred embodiment, the method comprises the additional step of providing instructions to a window heating control unit to select a rate at which to provide energy to at least one window heating element. The temperature may be measured by any suitable means, such as a local temperature probe in contact with the windscreen or an infrared temperatures sensor. This preferred embodiment also comprises providing the measured temperature of the windscreen to a processing unit. This preferred embodiment also comprises determining the optimal rate at which to provide outside (fresh) air to the cabin space to achieve calculated optimal relative humidity level, carbon dioxide level and preclude fogging of the window of the vehicle. It has been found that if the temperature of the window is close to the dew point of air within the cabin, misting of the windscreen can occur. Energy may suitably be provided to at least one window heating element to advantageously minimize or entirely preclude misting of the windscreen.

This embodiment advantageously allows for minimization of outside (fresh) air intake and window heating whilst maintaining safe and comfortable cabin carbon dioxide levels, cabin relative humidity levels and cabin temperature, whilst also preventing or at least minimizing window fogging. Minimization of both the outside (fresh) air intake and window heating advantageously allows for optimizing (reducing) energy use in vehicles comprising an air-circulation and -recirculation system and heated windows. This method is particularly advantageous for electric vehicles. In electric vehicles, HVAC system use constitutes a major part of the overall energy expenditure of the vehicle, and window heating as minor part of the overall energy expenditure. The claimed method advantageously extends the range of the vehicle by reducing battery use for both the HVAC system and window heating.

In a particularly preferred embodiment, the method comprises the additional steps of: (i) measuring the temperature of the windscreen using a temperature sensor; and (ii) providing instructions to a window heating control unit to select a rate at which to provide energy to at least one window heating element. The temperature of the windscreen may be measured by any suitable means, such as a local temperature probe in contact with the windscreen or an infrared temperatures sensor. This particularly preferred embodiment also comprises providing the measured temperature of the windscreen to a processing unit. This particularly preferred embodiment also comprises determining the optimal rate at which to provide outside (fresh) air to the cabin space to achieve calculated optimal relative humidity level, carbon dioxide level and preclude fogging of the window of the vehicle. It has been found that if the temperature of the window is close to the dew point of air within the cabin, misting of the windscreen can occur. The humidity of the air in the cabin can be decreased and energy suitably be simultaneously provided to at least one window heating element to advantageously minimize or entirely preclude misting of the windscreen.

In a preferred embodiment, the relative humidity and cabin temperature are measured at the same location within the cabin of the vehicle.

In a preferred embodiment, the relative humidity and window temperature are measured at the same location within the cabin of the vehicle.

In a preferred embodiment, the method additionally comprises the steps of providing original equipment manufacturer data concerning the cabin volume and HVAC operating parameters to a processing unit. Suitable HVAC operating parameters may include, for example, aperture size of one or more recirculation flaps and/or flow rate parameters.

Upper boundary value settings for (1) relative humidity level and (2) carbon dioxide level of air inside a cabin space of a vehicle may be input and stored on a memory unit of the processing unit.

In a preferred embodiment, the method comprises the additional step (vii) of providing the measured carbon dioxide level and relative humidity level to a vehicle control system. This preferred embodiment additionally allows the vehicle control system to provide real-time relative humidity level and carbon dioxide level to a vehicle user. Where the cabin temperature is measured as part of the claimed method according to the first aspect, the additional step (viii) additionally comprises providing the measured cabin temperature to the vehicle control system. Where the concentration of particulates in the cabin is measured as part of the claimed method according to the first aspect, the additional step (viii) additionally comprises providing the measured particulate levels to the vehicle control system. Where the level of volatile organic compounds in the cabin air is measured as part of the claimed method according to the first aspect, the additional step (viii) additionally comprises providing the measured cabin temperature to the vehicle control system. The data concerning carbon dioxide level, relative humidity level and optionally temperature, VOC and particulate levels may optionally be provided to the user by a vehicle control system's display unit, optionally by numeric, graphic and/or pictorial means. The data may optionally be provided to the user by means of a vehicles sound system. This advantageously allows the vehicle user to monitor the vehicles' air (re)circulation system(s) and identify issues faults with recirculation valves. The provision of this information may also provide peace of mind to the user of the vehicle. Where VOC level or particulate level is provided to the user, this advantageously allows the user to identify in real time that their VOC and or particulate filters, where present, need to be replaced.

In a preferred embodiment, the method comprises the additional step (vii) of providing the measured carbon dioxide level and relative humidity level to a mobile telephone or portable computing device, such as for example, a laptop computer. This preferred embodiment additionally allows the vehicle control system to provide real-time relative humidity level and carbon dioxide level to a vehicle user. Where the cabin temperature is measured as part of the claimed method according to the first aspect, the additional step (viii) additionally comprises providing the measured cabin temperature to the mobile telephone or portable computing device. Where the concentration of particulates in the cabin is measured as part of the claimed method according to the first aspect, the additional step (viii) additionally comprises providing the measured particulate levels to the vehicle control system. Where the level of volatile organic compounds in the cabin air is measured as part of the claimed method according to the first aspect, the additional step (viii) additionally comprises providing the measured cabin temperature to the vehicle control system. The data concerning carbon dioxide level, relative humidity level and optionally temperature, VOC and particulate levels may optionally be provided to the user by a mobile telephone or portable computing device display unit, optionally by numeric, graphic and/or pictorial means. The data may optionally be provided to the user by means of a mobile telephone's or portable computing device's sound system.

Preferably, the method according to any previous aspect is one in which the CO₂ concentration is maintained in the cabin below 5,000 ppm, more preferably below 4,000 ppm, even more preferably below 3,000 ppm, yet more preferably below 2,000 ppm, more preferably still below 1,500 ppm and most preferably below 1,100 ppm. This advantageously provides for passenger safety and comfort.

Preferably, the method according to any previous aspect is one in which the relative humidity is maintained below 60%. This advantageously provides for passenger comfort and/or precludes window fogging, the latter consequently reducing the risk of accidents.

Preferably, the method according to any previous aspect is one in which the windshield temperature is maintained above 0° C., more preferably above 5° C., even more preferably above 10° C., yet more preferably above 13° C., more preferably still above 14° C., and mores preferably above 15° C.

A second aspect of the disclosure concerns a vehicle energy optimization apparatus for use in any of the methods described above, comprising:
a. at least one carbon dioxide sensor;
b. at least one relative humidity sensor;
c. optionally at least one cabin temperature sensor;
d. at least one window temperature sensor;
e. at least one processing unit; and
f. at least one air-(re)circulation control unit;
wherein the at least one carbon dioxide sensor, the at least one relative humidity sensor, at least one cabin temperature sensor if present, the at least one window temperature sensor, the at least one processing unit and at least one air-recirculation control unit are configured to execute the steps of any of the methods according to the first aspect of the disclosure as described above.

The apparatus comprises at least one carbon dioxide sensor, which may be selected from any suitable commercially available carbon dioxide sensors capable of measuring the carbon dioxide level in the range of 350 to 15,000 ppm. The carbon dioxide sensor must be capable of outputting the measured carbon dioxide level as a computer readable signal. Preferably, the at least one carbon dioxide sensor has an accuracy over the range of 400 to 5000 ppm CO₂ at ambient conditions (pressure of 1013 mbar, temperature of 25° C., 50% relative humidity) of from 10 to 500 ppm CO₂, more preferably an accuracy of from 24 to 350 ppm CO₂, even more preferably of from 40 to 250 ppm CO₂, and most preferably an accuracy of 40 ppm CO₂+5% of the CO₂ reading value.

The apparatus comprises at least one relative humidity sensor, which may be selected from any suitable commercially available carbon dioxide sensors. The relative humidity sensor must be capable of measuring the relative humidity in the range of 0 to 100% relative humidity, when expressed as a percentage. Such a relative humidity sensor should be capable of outputting the measured relative humidity level as a computer readable signal. Preferably, the relative humidity sensor has an accuracy of 0-5% relative humidity, more preferably an accuracy of 0.1-4% relative humidity, even more preferably an accuracy of 0.3-3% relative humidity and most preferably 0.5-2% relative humidity.

The apparatus preferably comprises at least one cabin temperature sensor, which may be selected from any suitable commercially available temperature sensor. The cabin temperature sensor may have an operative temperature measurement range of −50° C. to +50° C., preferably, −40 to 45° C., more preferably −20 to 40° C., most preferably −10 to 35° C. Preferably, the cabin temperature sensor has an accuracy over the operative temperature measurement range of 0.1-1° C., more preferably 0.1-0.75° C. and most preferably 0.2-0.5° C.

The apparatus preferably comprises at least one window temperature sensor, which may be selected from any suitable commercially available temperature sensor. Suitable temperature sensors include thermometers in physical contact with the window. Suitable temperature sensors also include infrared temperature sensors. The window temperature sensor may have an operative temperature measurement range of −50° C. to +50° C., preferably, −40 to 45° C., more preferably −20 to 40° C., most preferably −10 to 35° C. Preferably, the window temperature sensor has an accuracy over the operative temperature measurement range of 0.1-1° C., more preferably 0.1-0.75° C. and most preferably 0.2-0.5° C. More preferably, the window temperature sensor is a front windscreen temperature sensor.

The apparatus comprises at least one air-(re)circulation control unit, which may be selected form any suitable commercially available vehicle air-(re)circulation control unit.

In a preferable embodiment, the at least one relative humidity sensor and the at least one cabin temperature sensor are provided as one combined relative humidity and temperature sensor unit. The combined relative humidity and temperature sensor unit is preferably provided as a surface mounted package, such that the components may be directly mounted on the surface of a printed circuit board (PCB). Preferably, the combined relative humidity and temperature sensor unit has an accuracy of 0.3-3% relative humidity and 0.1-1° C., more preferably has an accuracy of 0.5-2% relative humidity and 0.2-0.5° C.

In a particularly preferable embodiment, the at least one relative humidity sensor, the least one carbon dioxide sensor and the at least one cabin temperature sensor are provided as one combined relative humidity, carbon dioxide and temperature sensor unit. The combined relative humidity, carbon dioxide and temperature sensor unit are preferably provided as a surface mounted package, such that the components may be directly mounted on the surface of a printed circuit board (PCB). Preferably, the combined relative humidity, carbon dioxide and temperature sensor unit has an accuracy of 0.3-3% relative humidity, 25-500 ppm CO₂ and 0.1-1° C., more preferably has an accuracy of 0.5-2% relative humidity, 50-250 ppm CO₂ and 0.2-0.5° C.

In a preferable embodiment, the apparatus is configured so that the at least one processing unit may provide instructions to an air-control unit of a vehicle.

In a preferable embodiment, the apparatus is configured so that the sensors, processing and/or control unit may communicate via wireless signals. More preferably, the apparatus is configured so that the sensors, processing and/or control unit are capable of communicating via Bluetooth, Wi-Fi or infra-red signals.

Preferably, the apparatus additionally comprises an ambient temperature sensor and ambient relative humidity sensor. These sensors may suitably be located on the exterior of the vehicle or in an outside (fresh) air inlet of the vehicles HVAC system.

Preferably, the apparatus additionally comprises a recirculation flap configured to allow mixing of fresh air with recirculated air.

Preferably, the apparatus additionally comprises window heating means. More preferably, the apparatus additionally comprises window heating means located in or on the front windscreen. Even more preferably, the apparatus additionally comprises window heating means and a window temperature sensor located in or on the front windscreen.

Preferably, the at least one carbon dioxide sensor, the at least one relative humidity sensor, the at least one cabin temperature sensor and the at least one processing unit are located on a printed circuit board. More preferably, the at least one carbon dioxide sensor, the at least one relative humidity sensor, the at least one cabin temperature sensor and the at least one processing unit are located on a printed circuit board within a housing element, for example a plastic case.

Optionally, the apparatus additionally comprises a connection to a power source and/or an integrated power source, such as for example a battery or a solar panel. A window mounted solar panel element may be connected to the apparatus as the power source.

Preferably, the apparatus additionally comprises wireless connection means suitable for connecting to a mobile telephone or portable computing device, such as for example, a laptop computer.

A further aspect of the disclosure relates to a vehicle comprising the energy optimization apparatus as described above.

Preferably, the vehicle is an electric vehicle, a hybrid electric-combustion engine vehicle, a petrol combustion engine vehicle, or a diesel combustion engine vehicle, more preferably an electric vehicle or a hybrid electric-combustion engine vehicle, most preferably an electric vehicle.

Preferably the vehicle HVAC system additionally comprises fine particulate and/or VOC filters installed in the recirculation stream. These are configured to clean the recirculated cabin air from pollutants, irritants and/or foul smells.

A further aspect of the disclosure relates to a kit of parts for use in modifying a vehicle equipped with an air-circulation and -recirculation system; preferably an electric vehicle, a hybrid electric-combustion engine vehicle, a petrol combustion engine vehicle, or a diesel combustion engine vehicle, comprising:
a. at least one carbon dioxide sensor;
b. at least one relative humidity sensor;
c. optionally at least one cabin temperature sensor;
d. at least one window temperature sensor;
e. at least one processing unit; and
f. a control unit configured to interface with and control the vehicle's at least one air-(re)circulation control unit, wherein the sensors and the processing unit are configured to execute the steps of any of the methods according to the first aspect of the disclosure.

Preferably, the kit of parts is configured so that the sensors, processing and/or control unit are capable of communicating via wireless signals. More preferably, the kit of parts is configured so that the sensors, processing and/or control unit are capable of communicating via Bluetooth, Wi-Fi or infra-red signals.

Preferably, the window temperature sensor is a windscreen temperature sensor. More preferably, the window temperature sensor is a front windscreen temperature sensor. The front windscreen temperature sensor is preferably located in or on the top of the windscreen. The top of the window is defined as the uppermost 25% of the window by volume, where the direction up is opposite to the vector of gravitational acceleration, when the window is fitted to the vehicle. Even more preferably, the window temperature sensor is a front windscreen temperature sensor located on the inside surface (the cabin air contacting surface of the window) of the front windscreen. Most preferably, the window temperature sensor is a front windscreen temperature sensor located on the top, inside surface (the cabin air contacting surface of the window) of the front windscreen.

In a further aspect, the disclosure relates to a computer programme comprising instructions which, when the programme is executed by a computer, causes the computer to carry out any method according to the first aspect of the disclosure.

In a further aspect, the disclosure relates to computer-readable medium comprising instructions which, when executed by a computer, cause the computer to carry out the steps of any method according to the first aspect of the disclosure.

In a further aspect, the disclosure relates to a method of improving the energy efficiency of a vehicle comprising the steps of:
providing a vehicle with an air recirculation control unit;
installing at least one carbon dioxide sensor within the cabin of the vehicle;
installing at least one relative humidity sensor within the cabin of the vehicle;
installing at least one temperature sensor within the cabin of the vehicle;
installing at least one processing unit and control unit; and
configuring the control unit and air recirculation control unit to communicate such that the air (re)circulation unit executes the orders of the control unit.

Preferably the method additionally comprises the step of installing at least one window temperature sensor within the cabin of the vehicle, more preferably the step of installing at least one front windscreen temperature sensor.

In a further aspect, the disclosure relates to a method of providing a vehicle control system with real-time relative humidity level and carbon dioxide level data comprising the steps of:
measuring a carbon dioxide level of vehicle cabin air and a relative humidity level of cabin air; and
providing the measured carbon dioxide level, relative humidity level and temperature to the vehicle control system.

The carbon dioxide level of air inside a cabin space of a vehicle may be measured using a carbon dioxide sensor. Such a carbon dioxide sensor may be selected from commercially available carbon dioxide sensors capable of measuring the carbon dioxide level in the range of 350 to 15,000 ppm. The carbon dioxide sensor should be capable of outputting the measured carbon dioxide level as a computer readable signal. Preferably, the carbon dioxide level or air inside the cabin space is measured with an accuracy over the range of 400 to 5000 ppm CO₂ of from 10 to 500 ppm CO₂, more preferably an accuracy of from 24 to 350 ppm CO₂, even more preferably of from 40 to 250 ppm CO₂, and most preferably an accuracy of 40 ppm CO₂+5% of the CO₂ reading value.

The relative humidity level of air inside the cabin space of the vehicle may be measured using a relative humidity sensor. The relative humidity sensor may be selected from commercially available relative humidity sensors capable of measuring the relative humidity in the range of 0 to 100% relative humidity, when expressed as a percentage. Such a relative humidity sensor should be capable of outputting the measured relative humidity level as a computer readable signal.

The method comprises the step of providing the measured carbon dioxide level and relative humidity level and temperature to the vehicle control system. This may be realised by connecting the output of the sensors to the vehicle control system via wires.

Alternatively, the step of providing the measured carbon dioxide level, relative humidity level and temperature to a vehicle control system may be realised using wireless technology, in which the sensors output the information as electromagnetic radiation. The vehicle control system may be configured to receive the broadcast signals. Alternatively, the vehicle control system may be connected to a receiver configured to receive the broadcast signals, transduce these signals to conducted electrical signals and communicate these to the vehicle control system using wires. Suitable electromagnetic communication systems may be selected from short-range wireless technology such as Bluetooth, Wi-Fi or infra-red communication.

Alternatively, the step of providing the measured carbon dioxide level and relative humidity level and temperature to a vehicle control system may be realised using a combination of both wires and wireless technology as described above.

Preferably, the method step (i) additionally comprise measuring the cabin temperature and step (ii) additionally comprises providing the measured cabin temperature to the vehicle control system. The temperature inside the cabin space of the vehicle may be measured using a temperature sensor. The temperature sensor may be selected from commercially available temperature sensors. The temperature sensor should be capable of outputting the temperatures as a computer readable signal.

In a preferred embodiment, the method step (i) additionally comprise measuring the level of volatile organic compounds and step (ii) additionally comprises providing the measured level of volatile organic compounds to the vehicle control system. additional step of measuring the level of volatile organic compounds in the air inside the cabin space of a vehicle using volatile organic compound detection means. This preferred embodiment also comprises providing the measured level of volatile organic compounds (VOCs) in the air inside the cabin space to a processing unit. Methods of measuring levels of VOCs are known in the art, and any suitable method may be selected, for example by means of mass spectrometry or infrared detection. Preferably, an indexed aggregate VOC level may be measured and provided. This has the effect of allowing the vehicle user to monitor the VOC level in real time. This advantageously allows the vehicle user to determine if VOC removal means, if used, need to be replaced, or if using the vehicle is hazardous to health.

In a preferred embodiment, the method step (i) comprise measuring the level of particulates in the air inside the cabin space of a vehicle using particle detection means and step (ii) additionally comprises providing the measured level of particulates in the cabin air to the vehicle control system. This has the effect of allowing the vehicle user to monitor the particulate level in real time. This advantageously allows the vehicle user to determine if particulate filters, if used, need to be replaced. According this aspect of the disclosure, the data concerning carbon dioxide level, relative humidity level and optionally temperature, VOC and particulate levels may optionally be provided to the user by a vehicle control system's display unit, optionally by numeric, graphic and/or pictorial means. The data may optionally be provided to the user by means of a vehicles sound system. This advantageously allows the vehicle user to monitor the vehicles' air (re)circulation system(s) and identify issues faults with recirculation valves. The provision of this information may also provide peace of mind to the user of the vehicle. Where VOC level or particulate level is provided to the user, this advantageously allows the user to identify in real time that their VOC and or particulate filters, where present, need to be replaced.

### Vehicle Energy Optimisation Apparatus 1

A vehicle energy optimisation apparatus according to the disclosure was prepared. A printed circuit board (PCB) was made with an integrated relative humidity level sensor, a temperature sensor, a carbon dioxide sensor, a processing unit. This was connected to the control unit of a vehicle with an air-(re)circulation unit. A digital connection was established between the PCB and the vehicle HVAC controller, which allowed for control of a recirculation flap within the HVAC system. The sensors and processing unit were configured to execute the steps of the method according to the first aspect of the disclosure.

### Vehicle Energy Optimisation Apparatus 2

A vehicle energy optimisation apparatus according to the disclosure was prepared. A printed circuit board (PCB) was made with an integrated relative humidity level sensor, a temperature sensor, a carbon dioxide sensor, a processing unit. This was connected to the control unit of a vehicle with an air-(re)circulation unit and a heated window. A digital connection was established between the PCB and the vehicle HVAC controller, which allowed for control of a recirculation flap within the HVAC system. A digital connection was established between the PCB and the vehicles window heating controller, which allowed for control of the window heating element. The sensors and processing unit were configured to execute the steps of the method according to the first aspect of the disclosure.

### Industry Benchmark Conditions for Assessing HVAC Efficiency

The industry-standard benchmark conditions of −10° C. ambient temperature and a relative humidity>70% were used to calculate the reduction in outside (fresh) air requirement.

The industry standard HVAC system used according to its industry standard specifications for 1 to 4 occupants (30% recirculation) requires approximately 220 m³/h of outside (fresh) air intake to maintain safe and comfortable cabin carbon dioxide levels, cabin relative humidity levels and cabin temperature.

Vehicle energy optimisation apparatus 1 used according to the method of the first embodiment of the first aspect of the disclosure was calculated to require only 40 m³/h of outside (fresh) air intake to maintain safe and comfortable cabin carbon dioxide levels, cabin relative humidity levels and cabin temperature for one occupant. Vehicle energy optimisation apparatus 1 used according to the method of the first embodiment of the first aspect of the disclosure was calculated to require only 150 m³/h of outside (fresh) air intake to maintain safe and comfortable cabin carbon dioxide levels, cabin relative humidity levels and cabin temperature for four occupants.

HVAC power consumption for heating air from −10° C. was estimated as follows: at 0% recirculation 5.3 kW, at a benchmark 30% recirculation 4.4 kW, and at 100% recirculation 2.1 kW. The vehicle energy optimisation apparatus 1 used according to the method of the first embodiment of the first aspect of the disclosure therefore results in a reduction in heating power consumption of 1.9 and 0.8 kW compared to the benchmark conditions (for 1 and 4 occupants, respectively). For a standard electric vehicle this could allow for a range extension of up to 12% and 4% (for 1 and 4 occupants, respectively), but range extension will naturally depend on other factors, such as battery size and motor power consumption

Vehicle energy optimisation apparatus 2 used according to the method of the first embodiment of the first aspect of the disclosure was calculated to require only 40 m³/h of outside (fresh) air intake to maintain safe and comfortable cabin carbon dioxide levels, cabin relative humidity levels and cabin temperature for one occupant. Vehicle energy optimisation apparatus 1 used according to the method of the first embodiment of the first aspect of the disclosure was calculated to require only 150 m³/h of outside (fresh) air intake to maintain safe and comfortable cabin carbon dioxide levels, cabin relative humidity levels and cabin temperature for four occupants. Additional energy savings from reduced window heating was calculated to increase the range by 13% and 9% for 1 and 4 occupants, respectively.

### Simulations 1: Technical Effect of the Method According to the Present Disclosure

To assess the technical effect of the method according to the present disclosure, a simulation of use of the method was performed under “winter conditions”.

The simulated winter conditions were as follows:
Ambient temperature of −10° C.;
Relative humidity of 90%;
Ambient CO₂ concentration of 500 ppm;
Solar flux of 250 W/m²;
Heat emission per person 75 W;
Latent heat per person 43.9 W; and
CO₂ emission per person 38.5 g/h.

A one-dimensional model of the thermal management system was employed to evaluate the energy performance of the HVAC system (i) operated under various conditions not according to a method of the present disclosure and (ii) operated according to the method according to the first aspect of the disclosure. The HVAC mode without chiller was simulated in the heat pump—ambient mode.

The cabin of an electric car were simulated with 2 passengers. The following vehicle characteristics were simulated:
Class: compact;
Volume: 2.5 m³;
Average speed: 46.5 km/h;
Specific range (benchmark): 6.6 km/kWh;
Maximum range (benchmark): 300 km;
Total air flux: 250 kg/h;
Compressor isentropic efficiency: 0.7;
Number of passengers: 2; and
Simulated travel time: 3500 s.

The following target cabin conditions were employed:
Temperature: 22° C.;
CO₂ concentration<1,100 ppm;
Relative humidity: <60%; and
Window fogging: <1 (no fogging).

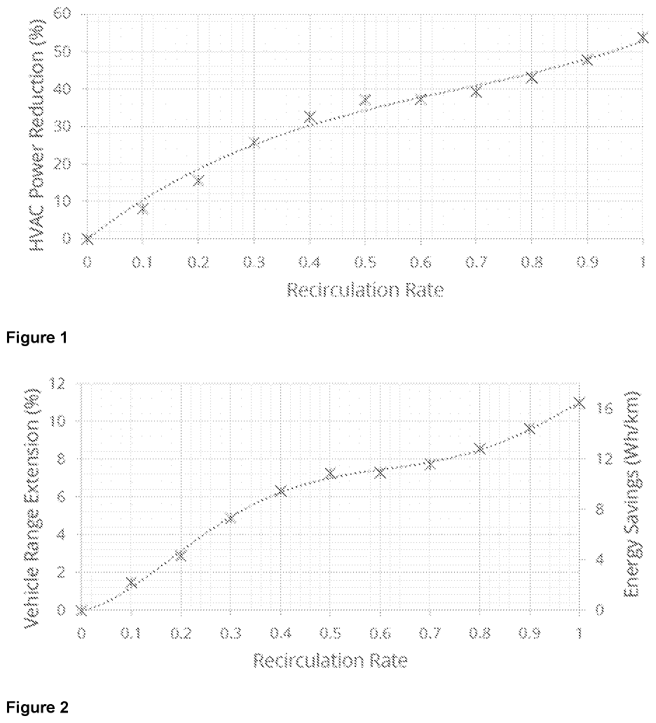

Under these conditions, simulation showed that HVAC power could be reduced by up to 54% if no outside air is used (i.e. under conditions of 100% recirculation). This is depicted in the graph of FIG. 1. This would correspond to a range extension of approximately 11% and an energy saving of up to 16 Wh/km. This is depicted in FIG. 2.

Increased recirculation rates are advantageous in terms of energy savings, but there is an upper limit on the amount of air that can be recirculated, which is imposed by safety and comfort considerations of the passengers of the vehicle.

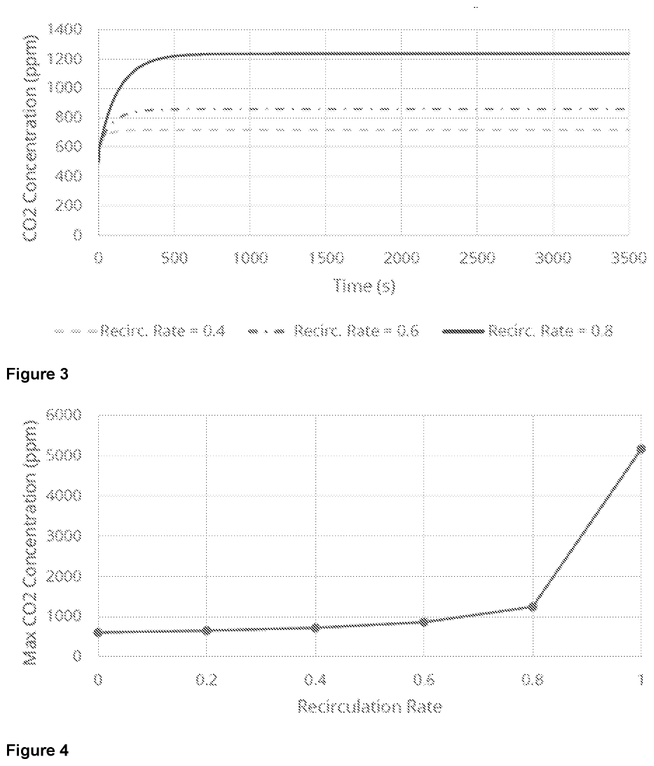

The effect of fractional recirculation was simulated for the conditions above and results as provided in FIGS. 3 and 4. FIG. 3 depicts the build-up of CO₂ concentration within the cabin (y-axis, ppm) against time (x-axis, s) under different recirculation rates (0.4, 0.6 and 0.8). FIG. 4 depicts the simulated maximum CO₂ concentrations observed within the cabin (y axis, ppm) against various recirculation rates (from zero to 1). It can be seen that with higher recirculation rates (from around 0.8 to 1), CO₂ concentrations at uncomfortable and dangerous levels are anticipated to occur within the 3500 s situation window.

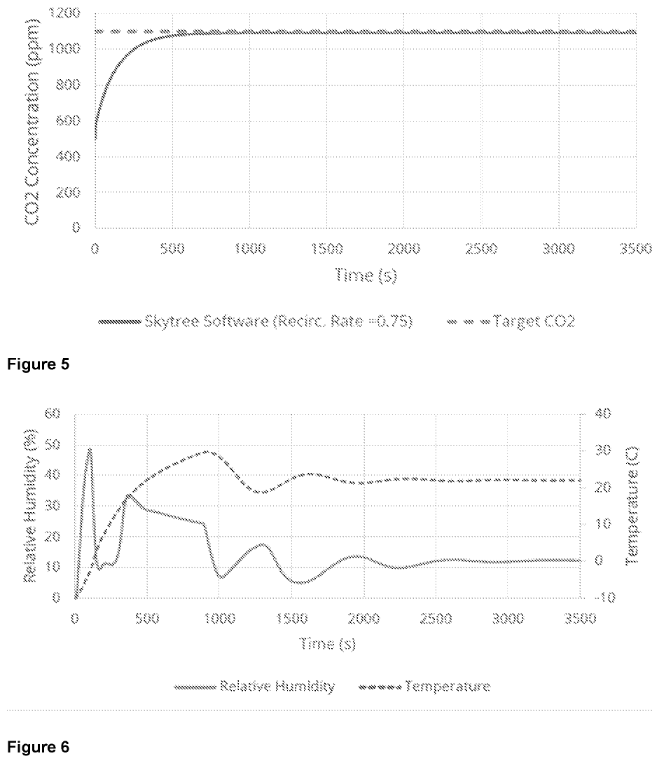

Based on the simulations, if you were to select (i) the maximum recirculation rate, whilst (ii) also not exceeding a CO₂ concentration of 1,100 ppm, for a vehicle under the conditions above, the maximum recirculation rate would be 0.75 (75% recirculated air, 0.25 outside [fresh] air). The results of this simulation are depicted in FIG. 5. FIG. 5 is a graph of CO₂ concentration (y-axis, ppm) against time (x-axis, s) for the recirculation rate of 0.75. The solid line is the CO₂ concentration that is obtained in the simulation, the hashed line is the maximum (target) CO₂ level. This would be the result of a method for optimizing energy use in vehicles comprising an air-circulation and air-recirculation system, with the method comprising the step of measuring only the CO₂ level.

The effect of fractional recirculation on relative humidity was also simulated for a recirculation rate of 0.75. The results of this simulation are depicted in the graph of FIG. 6. FIG. 6 is a graph of the relative humidity (left y-axis, %) and cabin temperature (right y-axis, ° C.) against time (x-axis, t), at a recirculation rate of 0.75, with relative humidity depicted by the hashed line and the temperature depicted by the solid line. For this specific case (two passengers, ambient temperature of −10° C. and a cabin target temperature of 22° C., recirculation rate of 0.75) the relative humidity levels do not exceed 50% during the heat-up phase (left hand side of the graph). This is sufficiently low to preclude fogging-up of the windshield or inducing discomfort in the vehicle passengers.

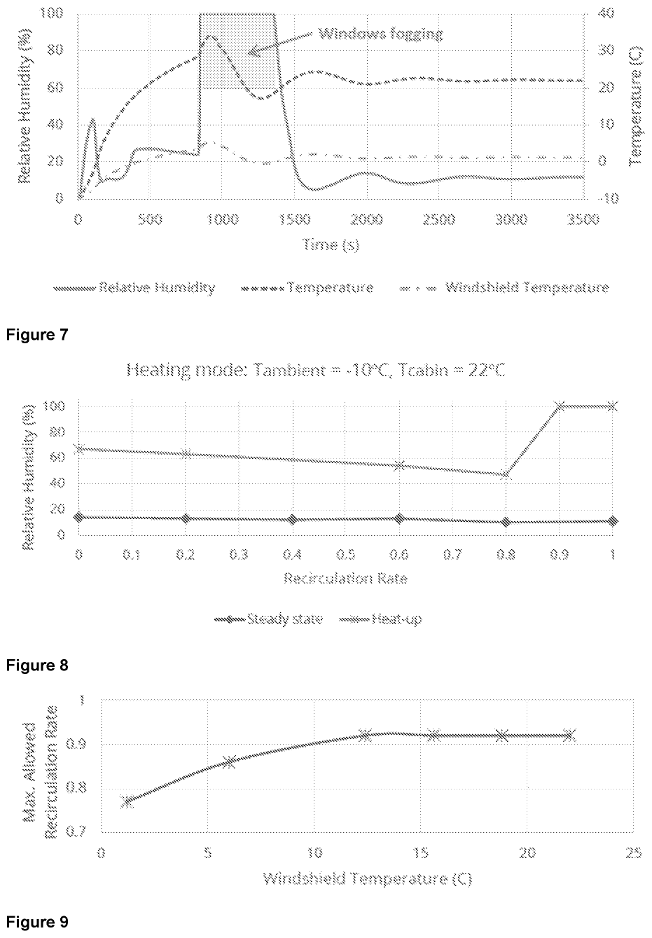

However, were a slightly higher recirculation rate selected (0.90), to operate with a safe if perhaps slightly uncomfortable, CO₂ concentration, then a simulation under the same conditions as above suggests that high relative humidity levels would be encountered, and window fogging-up would occur. The results of the simulation are depicted in FIG. 7. FIG. 7 is a graph of relative humidity (left y-axis, %) and temperature (right y-axis, ° C.) against time (x-axis, s), at a recirculation rate of 0.90. The shaded area corresponds to the region where window fogging is expected to occur. In this instance, it can be seen that relative humidity far exceeds 60%. This would generally be deemed uncomfortable by passengers. Further, under the simulation conditions would be expected to lead to window fogging, corresponding to a reduction in visibility and corresponding increased risk of accidents occurring. After the cabin temperature has reached a steady-state temperature of around 22° C., the relative humidity in the cabin under the simulated conditions is around 12%, which is in the comfort region and low enough to preclude window fogging.

The maximum relative humidity levels observed in the heat up phase for various recirculation rates under the conditions described above were simulated, and the results shown in FIG. 8. FIG. 8 is a graph of maximum cabin relative humidity observed (y-axis, %) against recirculation rate (x-axis, from zero to one) obtained from simulations in (i) the heat up phase and (ii) the steady-state condition.

Given the simulations, it is believed that the method according to the first aspect of the present disclosure advantageously allows for minimizing energy use in vehicles comprising an air-circulation and recirculation system, whist maintaining the CO₂ level and relative humidity level sufficiently low to ensure passenger safety, and further to ensure passenger comfort.

Simulations 2: Simulation of the Effect of an Embodiment of the Disclosure in which the Method Comprises the Step of Providing Instructions to a Window Heating Control Unit to Select a Rate at which to Provide Energy to at Least One Window Heating Element.

In the previous set of simulations (Simulations 1), it was shown that relative humidity could be the limiting factor for determining the optimal rate at which to provide outside air to the cabin to maintain passenger safety and/or comfort. Further simulations were conducted that determined the maximum allowed recirculation rate as a function of window temperature. The results of these simulations are depicted in FIG. 9. FIG. 9 is a graph of windshield temperature effect on maximum allowed recirculation rates. The maximum allowed recirculation rate (y-axis, 0.7 to 1.0) is plotted against the windshield temperature (° C.). The graph shows how the maximum allowed recirculation can be increased from 78% to 92% by heating up the window temperature (e.g. windshield, rear window, side windows, etc.). This increase in recirculation rate advantageously allows lower energy use. This is particularly advantageous for electric vehicles, as it allows for a dramatic extension in maximum range for electric vehicles.

### Representative Example of a Method for Optimizing Energy Use in Vehicles Comprising an Air-Circulation and -Recirculation System.

The method comprising the steps of:
i. measuring a carbon dioxide level of vehicle cabin air; a relative humidity level of cabin air and at least one temperature of at least one vehicle window, preferably a windshield; and
ii. providing the measured carbon dioxide level, relative humidity level and temperature to a processing unit;
iii. providing a desired cabin temperature and an indexed optimal carbon dioxide level to the processing unit;
iv. calculating deviation of the measured cabin air carbon dioxide level from the indexed optimal carbon dioxide level(s); calculating optimal cabin air relative humidity level based on desired cabin temperature; and, based on the calculation,
v. determining the optimal rate at which to provide outside air to the cabin to achieve calculated cabin air optimal relative humidity level and carbon dioxide level, and minimize energy use;
vi. determining the ratio between outside air provision and air-recirculation required to provide outside air to the cabin at the determined optimal rate; and
vii. providing instructions to the air-circulation and -recirculation control unit to provide outside air to the cabin of the vehicle at the optimal rate by varying the ratio between outside air provision and air-recirculation.
   Step v involved:
(i) calculating the maximum allowed recirculation rate based on maintaining a CO₂ level below 1,100 ppm (recirculation rate of 75%);
(ii) calculating the maximum allowed recirculation rate based on maintaining a relative humidity level below 60% (recirculation rate of 77%); and
(iii) calculating the maximum allowed recirculation rate based on windshield temperature (recirculation rate of 82%).
   Step vi involved selecting the lowest recirculation rate (75%) of the three calculated in step v.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method for optimizing energy use in vehicles comprising an air-circulation and -recirculation system, the method comprising the steps of:
(i) measuring a carbon dioxide level of vehicle cabin air, a relative humidity level of cabin air, and at least one temperature of at least one vehicle window;
(ii) providing the measured carbon dioxide level, relative humidity level, and temperature to a processing unit;
(iii) providing a desired cabin temperature and an indexed optimal carbon dioxide level to the processing unit;
(iv) calculating deviation of the measured cabin air carbon dioxide level from the indexed optimal carbon dioxide level(s), calculating optimal cabin air relative humidity level based on desired cabin temperature;
(v) determining, based on the calculations of step (iv) the optimal rate at which to provide outside air to the cabin to achieve calculated cabin air optimal relative humidity level and carbon dioxide level and minimize energy use;
(vi) determining the recirculation rate required to provide outside air to the cabin at the determined optimal rate; and
(vii) providing instructions to the air-circulation and -recirculation control unit to provide air to the cabin of the vehicle at the optimal rate.

2. The method according to claim 1, wherein step (i) additionally comprises measuring the cabin temperature and step (ii) additionally comprises providing the measured cabin temperature to a processing unit.

3. The method according to claim 1, wherein the step of measuring at least one temperature of at least one window is measuring at least one temperature of the front windscreen.

4. The method according to claim 1, wherein the method is performed continuously during the use of the vehicle, and/or as a computer-implemented method.

5. The method according to claim 1, comprising additionally:
measuring the concentration of particulates in the cabin air, measuring the level of volatile organic compounds in the cabin air, and/or measuring the internal windscreen temperature at the coldest point of the windscreen.

6. The method according to claim 1, further comprising:
providing instructions to a window heating control unit to select a rate at which to provide energy to at least one window heating element.

7. A vehicle energy optimization apparatus for use in optimizing energy use in vehicles comprising an air-circulation and -recirculation system, comprising:
a) at least one carbon dioxide sensor;
b) at least one relative humidity sensor;
c) at least one window temperature sensor;
d) at least one processing unit; and
e) at least one air-(re)circulation control unit;
wherein the at least one carbon dioxide sensor, the at least one relative humidity sensor, the at least one window temperature sensor, the at least one processing unit and at least one air-recirculation control unit are configured to execute the steps of the methods of claim 1.

8. The apparatus according to claim 7, wherein the at least one processing unit is configured to provide instructions to an air-control unit of a vehicle.

9. A vehicle comprising the energy optimization apparatus according to claim 7.

10. The vehicle according to claim 9, wherein the vehicle is an electric vehicle, a hybrid electric-combustion engine vehicle, a petrol combustion engine vehicle, or a diesel combustion engine vehicle.

11. A kit of parts for modifying a vehicle equipped with an air-circulation and -recirculation system, comprising:
a) at least one carbon dioxide sensor;
a) at least one relative humidity sensor;
c) at least one window temperature sensor;
d) at least one processing unit; and
e) a control unit configured to interface with, and control the vehicle's at least one air-(re)circulation control unit, wherein the sensors and the processing unit are configured to execute the steps of the methods of claim 1.

12. An apparatus according to claim 7, wherein the sensors, processing and/or control unit are communicating via wireless signals.

13. A computer programme comprising instructions which, when the programme is executed by a computer, causes the computer to carry out the method of claim 1.

14. A computer-readable medium comprising instructions which, when executed by a computer, cause the computer to carry out the steps of the method of claim 1.

15. A method of improving the energy efficiency of a vehicle comprising the steps of:
providing a vehicle with an air recirculation control unit;
installing at least one carbon dioxide sensor within the cabin of the vehicle;
installing at least one relative humidity sensor within the cabin of the vehicle;
installing at least one temperature sensor within the cabin of the vehicle;
installing at least one processing unit and control unit; and
configuring the control unit and air recirculation control unit to communicate such that the air (re)circulation unit executes the orders of the control unit.

16. A method of providing a vehicle control system with real-time relative humidity level and carbon dioxide level data comprising the steps of:
a) measuring a carbon dioxide level of vehicle cabin air and a relative humidity level of cabin air; and
b)
providing the measured carbon dioxide level, relative humidity level, and temperature to the vehicle control system; and/or
displaying the measured carbon dioxide level, relative humidity level, and temperature to a vehicle driver.

17. The method according to claim 3, wherein the step of measuring at least one temperature of at least one window is measuring at least one temperature of the inside surface of the front windscreen.

18. The method according to claim 3, wherein the step of measuring at least one temperature of at least one window is measuring the temperature of the inside surface of the front windscreen at the top of the windscreen.

19. The vehicle energy optimization apparatus of claim 7, further comprising at least one cabin temperature sensor.
